(19) United States
(12) Patent Application Publication
(10) Pub. No.: US 2014/0046774 A1
(43) Pub. Date: Feb. 13, 2014

(54) SERVER AND SYSTEM FOR STREETLIGHT ADVERTISING

(71) Applicants: TE-SHENG CHEN, Miaoli (TW); XIAO-GUANG LI, Shenzhen (CN); KUAN-HONG HSIEH, New Taipei (TW); YUN XIAO, Shenzhen (CN); SHANG-HUI PI, Shenzhen (CN); SHUANG RUI, Shenzhen (CN)

(72) Inventors: TE-SHENG CHEN, Miaoli (TW); XIAO-GUANG LI, Shenzhen (CN); KUAN-HONG HSIEH, New Taipei (TW); YUN XIAO, Shenzhen (CN); SHANG-HUI PI, Shenzhen (CN); SHUANG RUI, Shenzhen (CN)

(21) Appl. No.: 13/729,060

(22) Filed: Dec. 28, 2012

(30) Foreign Application Priority Data
Aug. 10, 2012 (CN) 2012102837933

(51) Int. Cl. G06Q 30/02

(52) U.S. Cl. CPC G06Q 30/0269
USPC 705/14.66

(57) ABSTRACT

A server includes a communicating unit, a storage unit, and a control unit. The communicating unit communicates with a plurality of clients and a plurality of streetlights, receives advertisements from the plurality of clients, and information of a user's personal consumption preference sent by and from each of the streetlights. The storage unit stores the advertisements provided by the plurality of clients. The control unit obtains the advertisements from the storage unit according to the information of the user's personal consumption preference transmitted by and from a streetlight, and controls the communicating unit to transmit the obtained advertisements to the streetlight. A related system is also provided.

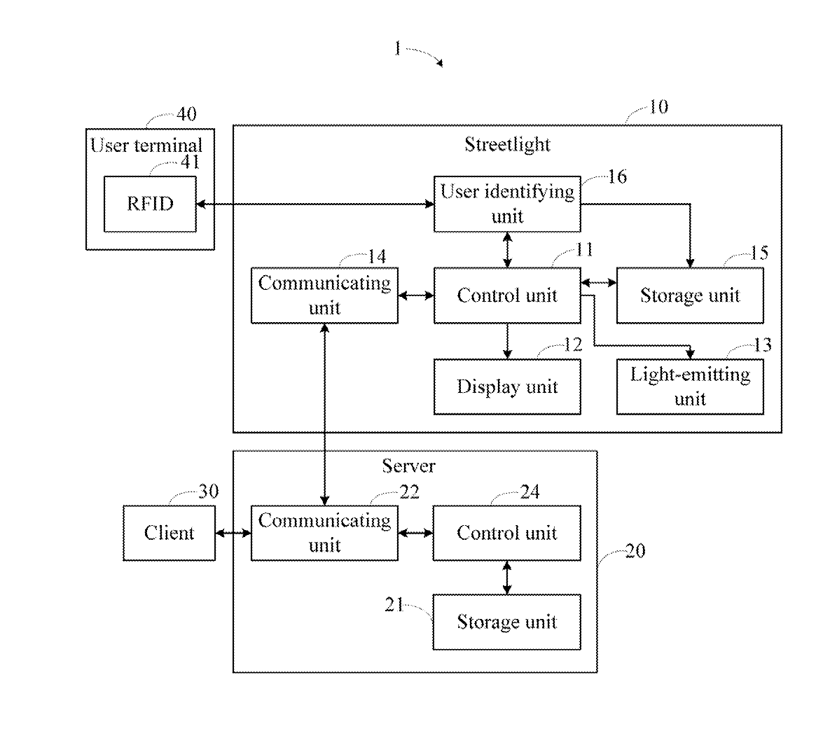

### BACKGROUND

1. Technical Field

The present disclosure relates to a streetlight, a server and a system for streetlight advertising.

2. Description of the Related Art

Traditional streetlights have been provided in many places for illuminating within a predetermined time interval only. A lamphouse is employed on each streetlight for displaying advertisements which are changed after a predetermined time by workers. In that case, the traditional streetlights with lamphouses only can provide the advertisements the workers preset it to be displayed for passengers. Therefore, there is room for improvement within the art.

### BRIEF DESCRIPTION OF THE DRAWING

The components in the drawing are not necessarily drawn to scale, the emphasis instead being placed upon clearly illustrating the principles of the disclosure.

The FIGURE is a block diagram of a system for advertising according to an exemplary embodiment.

### DETAILED DESCRIPTION

The FIGURE shows a system 1 for advertisement. The system 1 includes a plurality of streetlights 10, a server 20, a plurality of clients 30, and a plurality of user terminals 40. The plurality of streetlights 10, the plurality of clients 30, and the plurality of user terminals 40 communicate with the server 20 via a network, such as Power Line Communication (PLC), Optical Power Line Communication (OPLC), Zigbee, WiFi, 3G, 4G, GPRS, CDMA, GSM, or Satellite communication (SATCOM), for example. In the embodiment, the server 20 is a computer.

Each of the plurality of clients 30 transmits advertisements carrying an identifier of the client 30 to the server 20 via the network at predetermined time intervals. Each of the advertisements includes image information and a type information. The type information indicates categories, such as a dining type, an entertainment type, and a shopping type, and the like.

The server 20 includes a storage unit 21, a communicating unit 22, and a control unit 23. The communicating unit 22 communicates with the plurality of streetlights 10 and with the plurality of clients 30. The storage unit 21 stores the advertisements transmitted by the plurality of clients 30.

Each streetlight 10 includes a control unit 11, a display unit 12, a light-emitting unit 13, a communicating unit 14, a storage unit 15, and a user identifying unit 16. The display unit 12 and the light-emitting unit are mounted towards outside of the streetlight 10. The communicating unit 14 communicates with the server 20.

Each user terminal 40 includes a radio frequency identification (RFID) device, configured for storing consumer information and/or user information. The consumer information includes the type information of preferred advertisements of users, the type information of preferred advertisements of a user is pre-set by the user who logs in to the server 20. For example, the advertisements provided by a preferred restaurant, and/or a preferred super market, and/or a cinema, of a user may be pre-set by the user to be his preferred advertisements. In the embodiment, the user terminal 40 is a mobile phone, and the user information is a telephone number of the mobile phone. In an alternative embodiment, the user terminal 40 is a car, and the user information is a license number of the car.

In the embodiment, the user identifying unit 16 is a near field communication (NFC) module, in an alternative embodiment, the user identifying unit 16 is a radio frequency identification (RFID) module.

The user identifying unit 16 is mounted towards outside of the streetlight 10 and detects the RFIDs 41 of the user terminals 40 within a predetermined range and obtains consumer information stored in the RFIDs 41. The control unit 11 controls the communicating unit 14 to transmit the obtained consumer information to the server 20. The control unit 23 of the server 20 obtains the advertisements from the storage unit 21 according to the type information of the consumer information transmitted by the streetlight 10, and controls the communicating unit 22 to transmit the obtained advertisements to the streetlight 10 which transmitted the consumer information. When the streetlight 10 receives the advertisements transmitted by the server 20 via the communicating unit 14, the display unit 12 on the streetlight 10 displays the received advertisements.

In a first embodiment, the user information stored in the RFID 41 includes a first identifier, which is assigned by the server 20 when the user registers in the server 20. In the embodiment, the first identifier is a universal identifier, namely, the first identifiers of all the registered users are the same. The storage unit 15 further pre-stores a second identifier. When the user identifying unit 16 detects and obtains the user information and the consumer information of the user terminal 40, the control unit 11 determines whether the user of the user terminal 40 is a registered user by comparing the first identifier of the obtained user information with the second identifier stored in the storage unit 15. When the first identifier of the obtained user information matches the second identifier stored in the storage unit 15, the control unit 11 determines that the user of the user terminal 40 is a registered user, and controls the communicating unit 14 to transmit the obtained consumer information to the server 20. When the first identifier of the obtained user information is different from the second identifier stored in the storage unit 15, the control unit 11 determines the user of the user terminal 40 is not a registered user, and does not respond.

In a second embodiment, the control unit 11 controls the communicating unit 14 to transmit the obtained user information and the consumer information to the server 20. When the server 20 receives the user information and the consumer information transmitted by the streetlight 10, the control unit 23 determines whether the user of the user terminal 40 is a registered user by parsing the user information. When the user of the user terminal 40 is determined to be a registered user, the control unit 23 determines the advertisements according to the consumer information.

In a third embodiment, the RFID 41 of the user terminal 40 is encrypted. The user identifying unit 16 obtains the RFID 41 of the user terminal 40 of registered users only.

The storage unit 15 further pre-stores location information of the streetlight 10, and the storage unit 21 of the server 20 further pre-stores location information of the plurality of streetlights 10. The control unit 11 of the streetlight 10 further controls the communicating unit 14 to transmit the location information of the streetlight 10 to the server 20 together with the consumer information. The control unit 23 determines a plurality of streetlights before and behind the streetlight 10, within a predetermined range. For example, the control unit 23 determines that there are five streetlights 10 behind the instant streetlight 10. The control unit 23 controls the communicating unit 22 to transmit the obtained advertisements to the determined five streetlights 10 as well as to the instant streetlight 10. The display units 12 of all the streetlights 10 display the received advertisements about the same time.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A server comprising:
a communicating unit configured for communicating with a plurality of clients and a plurality of streetlights, receiving advertisements from the plurality of clients, and further receiving information of a user's personal consumption preference sent by and from each of the streetlights;
a storage unit configured for storing the advertisements provided by the plurality of clients; and
a control unit configured for obtaining the advertisements from the storage unit according to the information of the user's personal consumption preference transmitted by and from a streetlight, and controlling the communicating unit to transmit the obtained advertisements to the streetlight.

2. The server as claimed in claim 1, wherein the control unit further configured for determining whether the user is a registered user, the control unit determines the advertisements according to the information of the user's personal consumption preference only if the user is a registered user.

3. The server as claimed in claim 1, wherein the storage unit further pre-stores streetlight location information of the plurality of streetlights, the control unit determines a plurality of streetlights adjacent to the streetlight within a predetermined distance from the streetlight from which the server receives the information of the user's personal consumption preference, and controls the communicating unit to transmit the obtained advertisements to the determined plurality of adjacent streetlights.

4. A system comprising:
a plurality of streetlights,
a server, and
a plurality of clients, each of the plurality of streetlights comprising:
a light source;
a first communicating unit configured for communicating with the server;
a user identifying unit configured for detecting radio frequency identifications (RFID) of a plurality of user's mobile terminals which appear within a predetermined distance from said streetlight, and obtaining information of the users' personal consumption preference stored in the corresponding RFID;
a first control unit configured for controlling the first communicating unit to transmit the obtained information of the users' personal consumption preference to the server;
the server comprising:
a first storage unit configured for storing the advertisements provided by the plurality of clients
a second communicating unit configured for communicating with the plurality of clients and the plurality of streetlights, receiving the information of the users' personal consumption preference sent by and from the streetlights; and
a second control unit configured for obtaining the advertisements from the first storage unit according to the type of the information of the users' personal consumption preference, and controlling the second communicating unit to transmit the obtained advertisements to the streetlight.

5. The system as claimed in claim 4, wherein the user identifying unit is a near field communication module.

6. The system as claimed in claim 4, wherein the user identifying unit is a radio frequency identification module.

7. The system as claimed in claim 4, wherein each streetlight further comprises a second storage unit, configured for pre-storing streetlight location information thereof, the first storage unit is further configured for pre-storing streetlight location information of the plurality of streetlights; the second control unit determines a plurality of streetlights located within a predetermined distance from the streetlight from which the server receives the information of the user's personal consumption preference, and controls the second communicating unit to transmit the obtained advertisements to the determined adjacent streetlights.
